(19) United States
(12) Patent Application Publication
(10) Pub. No.: US 2008/0277839 A1
(43) Pub. Date: Nov. 13, 2008

(54) Co-Injection Molding System, Method of Injection Molding a Composite Structure and Article Formed Thereby

(75) Inventor: Edward C. Smith, Sterling Heights, MI (US)

Correspondence Address: BROOKS KUSHMAN P.C., 1000 TOWN CENTER, TWENTY-SECOND FLOOR, SOUTHFIELD, MI, 48075, US

(73) Assignee: PLASTIC MOLDED TECHNOLOGIES, INC., Shelby Township, MI (US)

(21) Appl. No.: 11/745,130

(22) Filed: May 7, 2007

(51) Int. Cl. B29C 45/22

(52) U.S. Cl. 264/513; 425/573; 428/36.4; 428/36.91

(57) ABSTRACT

A system, a method and an article made thereby are disclosed relating to the formation of a hollow structural plastic molded member having an exterior surface of a first plastic material and an inner layer of a second different structural plastic material which extends about an elongate hollow cavity. A representative example illustrates a railing member such as a spindle or post of a first thermal plastic outer appearance layer and an internal structural layer of fiber filled thermoplastic material extending about an elongate hollow cavity.

### BACKGROUND OF THE INVENTION

1. Field of the Invention

The present invention relates to co-injection molding machines, methods for forming co-injected hollow plastic structures and the resulting articles formed thereby.

2. Background Art

A variety of approaches have been taken to manufacture structural elongate plastic members in order to provide the necessary structure, while controlling part cost. An area in which plastic elongate structures are gaining in popularity is in the fabrication of railing systems for decks and porches. The trend toward plastic railing systems is driven primarily by the demand for a maintenance free deck or porch. While it is relatively simple to manufacture the horizontal hand rail and bottom rail in a railing system out of an aluminum structural extrusion capped with a separately extruded vinyl member, non-axially uniform posts and spindles cannot be so easily fabricated. Typically, posts for a vinyl railing system are simple vinyl extrusions telescopically fit over a wood post. Alternatively, vinyl can be overmolded about a wood post by injection molding. In order to avoid rot, chemically pressured treated wood is preferably used.

The spindles which vertically span between the hand rail and the lower rail in a rail system are commonly fashioned to resemble traditional turned wood spindles. This configuration can be achieved in plastic by blow molding a vinyl tubular extrusion which is heated and inserted into a closed molded desired shape and inflated to conform to the mold interior periphery. While complex shapes can be achieved using this blow molding technique, the resulting tubular vinyl product, if provided with a very thick wall, becomes expensive and if provided with a thin wall, lacks structural rigidity. Alternative approaches have been utilized to provide a structural spindle such as insert injection molding a plastic exterior about a wood or steel rod insert. However, these designs are expensive and heavy.

The applicant seeks to design a system and method capable of manufacturing low cost structural members having an exterior surface provided by a thin layer of appearance quality plastic having a good appearance and environmental properties with an interior formed of a rot resistance light-weight low cost material.

### SUMMARY OF THE INVENTION

The present invention includes a system and method for plastic injection molding elongate structural members and the resulting articles molded thereby, particularly well suited for, but not limited to structural railing members such as railing posts and railing spindles. One embodiment of the invention is provided by a plastic injection molding system which includes a mold clamp adapted to receive a mold for forming a plastic part. The mold has at least two sections movable relative to one another by a mold clamp actuator. A co-extruded unit feeds fluid plastic into the mold cavity. The co-extruder at least two plastic extruders, each having a different plastic material source and at least one outlet communicating with mold cavity. The fluid assist unit is further provided for providing a controllable metered injection of pressurized gas or liquid into the mold cavities sequentially following the injection of metered quantities of each plastic fluid. The controller regulates the operation of the mold clamp, the two plastic extruders and the gas or liquid assist unit to form a hollow plastic part having an exterior shell of a first material and an inner structural shell of a second plastic material and an internal hollow cavity all formed in a single molding station.

Preferably, each of the two plastic extruders in the co-extruder unit are each provided with a heater for heating thermoplastic material to a fluid state and a pump for transferring pressurized plastic fluid from the extruders through the outlet nozzle and to the mold cavity.

The method of forming a molded elongate article includes the step of providing a mold for forming an elongate structural member and installing the mold in a dual injection molding machine which is provided with a gas or fluid assist system. A metered amount of a first fluid plastic material is injected into the mold partially filling the cavity and contacting the mold cavity walls. Next, a second fluid plastic material, which is different than the first plastic material, is injected into the mold cavity displacing the first plastic material along the mold in contact with the mold walls forming a thin layer separating the second plastic material from the mold. Finally, pressurized gas is injected into the center of the mold occupied by the second fluid plastic material forming an axially elongate cavity and displacing both the first and second plastic materials from the entire length of the mold with the first material in contact with the mold wall to form a thin layer of first material separating the second layer of material from the mold walls. The pressurized gas is then vented and the molded part is removed from the mold cavity.

Preferably, the method is carried out utilizing a first and second thermoplastic material which are heated in the co-extruder machine to a fluid state. Ideally, the first fluid plastic material is in appearance quality UV stable thermoplastic such as vinyl. The second plastic material may be of lower cost thermoplastic with good structural properties such as fiber filled recycled thermoplastic.

The invention is further directed toward elongate structural members particularly, elongate railing members such as railing posts and railing spindles. The elongate members are provided with a thin tubular plastic skin layer of a first appearance quality material forming an exterior surface and a plastic inner layer of a second structural member different from the outer skin and formed conformably to the plastic outer layer and defining a hollow elongate internal cavity in a single molding operation. Preferably, the first and second plastic materials are thermoplastic such as a vinyl outer layer and a fiber reinforced recycled thermoplastic inner layer.

### BRIEF DESCRIPTION OF THE DRAWINGS

FIG. 1 illustrates a railing system of the present invention installed on a deck;

FIG. 2 illustrates a cross-sectional view of a spindle of the present invention;

FIG. 3a-3d illustrate a sequential series of steps in which a spindle of the present invention is formed in a single molding operation;

FIG. 4 is a flow chart describing the method of the present invention;

FIG. 5 is a schematic illustration of a molding system of the present invention; and

FIG. 6-10 illustrate a series of drawings depicting an alternative molding system of the present invention.

### DETAILED DESCRIPTION OF THE PREFERRED EMBODIMENT(S)

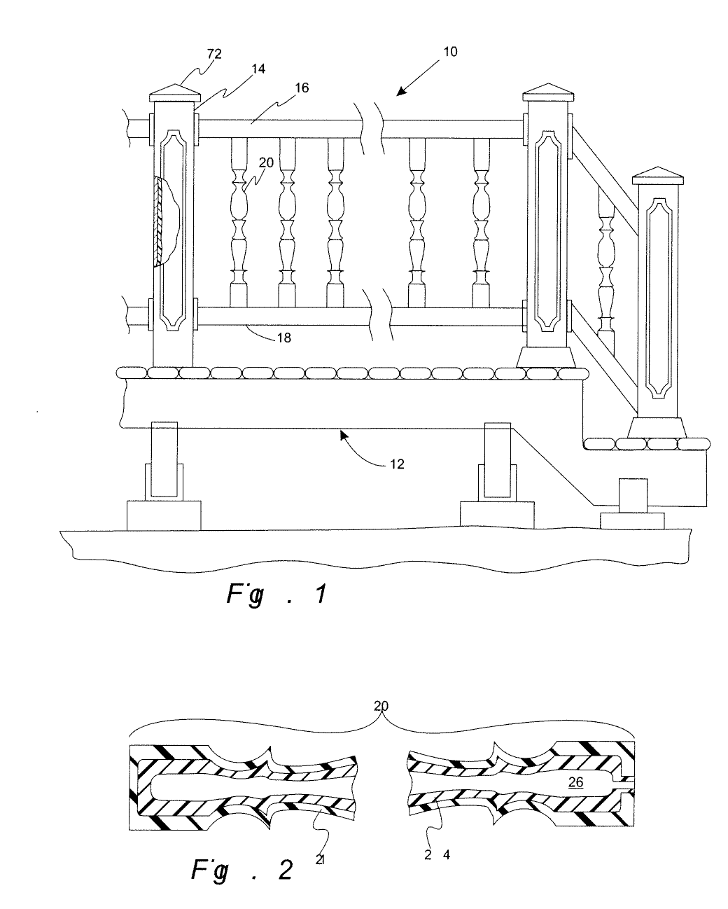

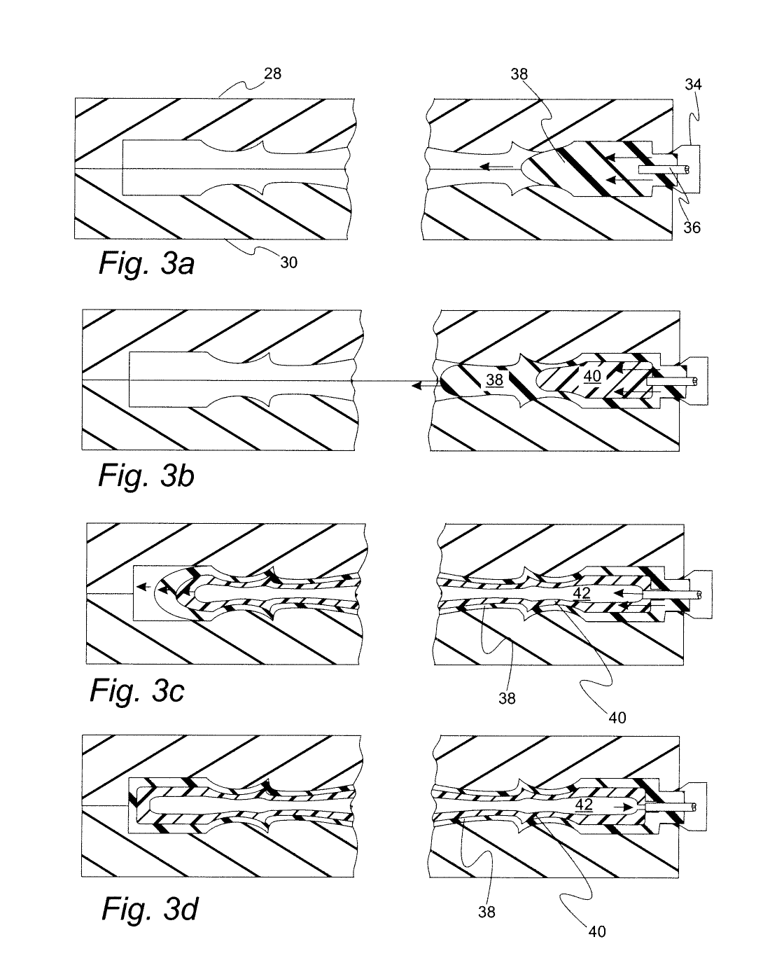

FIG. 1 illustrates a railing system 10 made in accordance with the present invention, installed upon a deck 12. The railing system includes a series of posts 14, hand rail 16, lower rail 18 and a series of spindles 20 which vertically span between hand rail 16 and lower rail 18. Hand rail 16 and lower rail 18 are made in a conventional manner, such as providing a structurally rigid aluminum extrusion capped with a separately extruded elongate vinyl extrusion to provide structural rigidity and a maintenance free exterior surface. Posts 14 and spindles 20 are made of a two-layer molded plastic composite. Spindle 20 is shown in a cutaway cross-sectional side elevation in FIG. 2. The spindle is provided with an outer skin 22 of an appearance quality UV stable plastic. Inboard of the skin layer 22 is a structural plastic inner layer 24 formed of a less expensive material having good structural qualities. Hollow axial cavity 26 extends substantially the entire length of spindle 20 as illustrated. Preferably, the outer first plastic skin layer 22 is formed of a thermoplastic material, such as vinyl, i.e. PVC, which is commonly used in outdoor fencing and rails. Of course, other thermoplastics as well as other thermoset plastic materials can be substituted by one skilled in the art if desired. The inner structural layer 24 is likewise preferably formed of thermoplastic material such as polyurethane, polypropylene or recycled thermoplastic waste. In order to lower cost and improve structural rigidity, the inner thermal plastic layer 24 may be blended with a filler such as organic fillers like wood flour or wood fiber or inorganic fillers such as plastic fibers, glass fibers or mineral fillers.

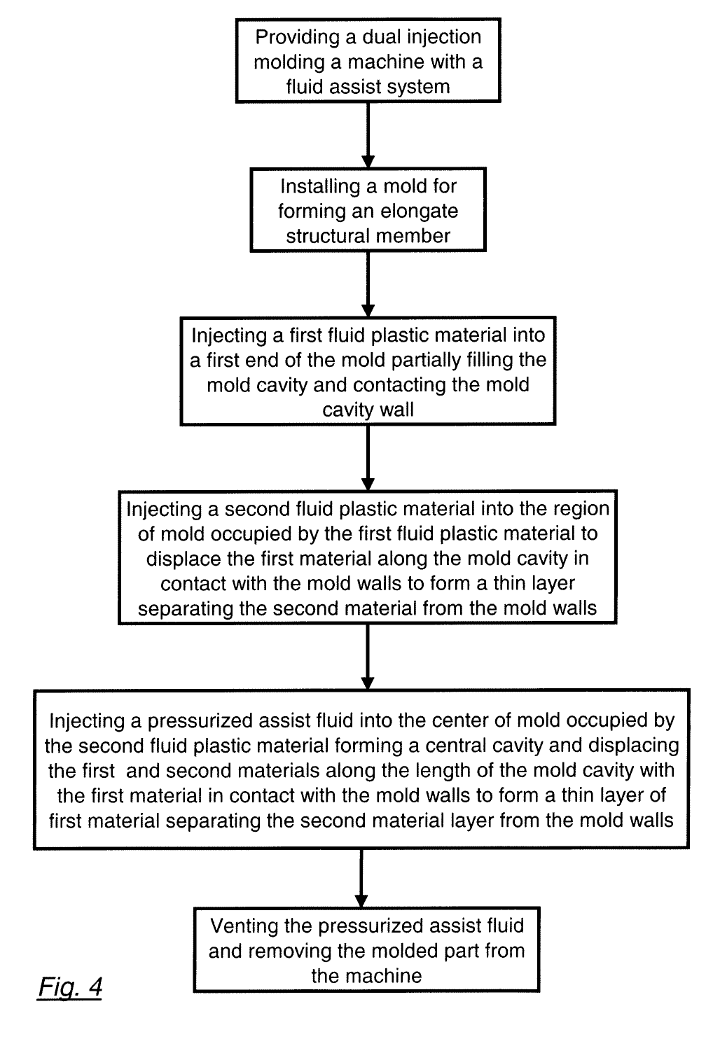

FIG. 3a through 3d illustrate a series of plastic injection steps utilized to form spindle 20 of FIG. 2. In FIG. 3a, a mold having first and second mold portions 28 and 30, is closed to define an internal mold cavity 32 in the shape of the spindle 20 to be formed. An injection nozzle 34 is positioned in a mold inlet port as shown. Injection nozzle 34 provides an annular injection port extending between the interior bore of nozzle 34 and the exterior periphery of gas injection pin 36. In the first stage of the injection process, a first fluid material 38 is injected into one end of the mold cavity 32 by the injection nozzle 34 as illustrated. The first fluid plastic material only partially fills the mold.

Following the injection of the first plastic material, a second plastic material 40 is injected through the injection nozzle 34. The introduction of the second fluid plastic material 40 causes the first fluid plastic material 38 to translate axially along mold cavity 32 contacting the walls of the mold and forming a thin plastic layer adjacent the mold wall as illustrated. The second fluid plastic material and the first fluid plastic material collectively, take up less than all of the interior cavity volume as illustrated in FIG. 3b. Once the second fluid plastic material has been substantially injected into the mold, a pressurized gas is injected through gas pin 36 as shown in FIG. 3c. The gas forms an internal hollow cavity 42, which, as it grows, causes the first fluid material and the second fluid material to move axially along the length of the mold cavity 32 as indicated by the direction arrows in FIG. 3c. The injection of gas continues until the mold is fully packed out with the first plastic material conformably engaging the interior surface of the mold. Once the first and second plastic materials are cooled sufficient to prevent a part deformation or deformation of shrink lines, the gas is vented from the internal axial cavity 42 as illustrated in FIG. 3d, whereupon the mold may be opened and the part ejected by a conventionally injected pin or the like.

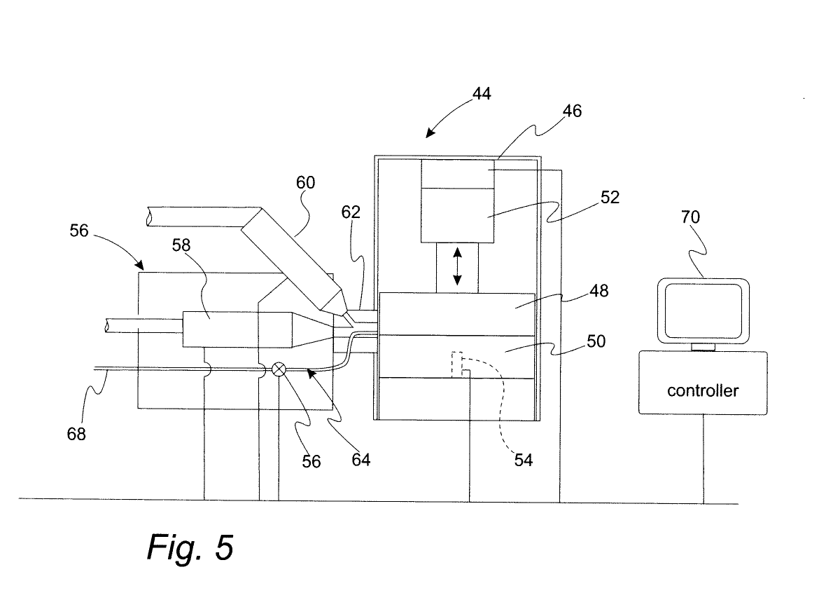

FIG. 4 illustrates the method of the present invention in a block diagram format. The initial step is providing a dual injection molding machine with a gas assist system. A mold for forming an elongate structure having the desired cavity shape is installed in the molding machine. With the mold closed, a first fluid plastic material is injected into one end of the elongate mold partially filling the mold cavity and contacting the mold walls. Next, a second fluid plastic material is injected into the region of the mold occupied by the first plastic fluid in order to displace the first material along the mold in contact with the mold walls in order to form a thin layer which separates the second material from the mold walls. Once substantially all of the second fluid plastic material has been introduced into the mold cavity, pressurized gas is injected into the center of the mold occupied by the second plastic fluid adjacent the first end of the cavity causing the first and second plastic materials to flow along the length of the mold cavity and ultimately packing out the mold with the first material in contact with the mold walls to form a thin first material layer which separates the second material layer of the mold walls. Once the first and second plastic materials are cured sufficiently to be conventionally stable, the pressurized gas is vented from the internal axial cavity in the part and the molded part is removed from the machine.

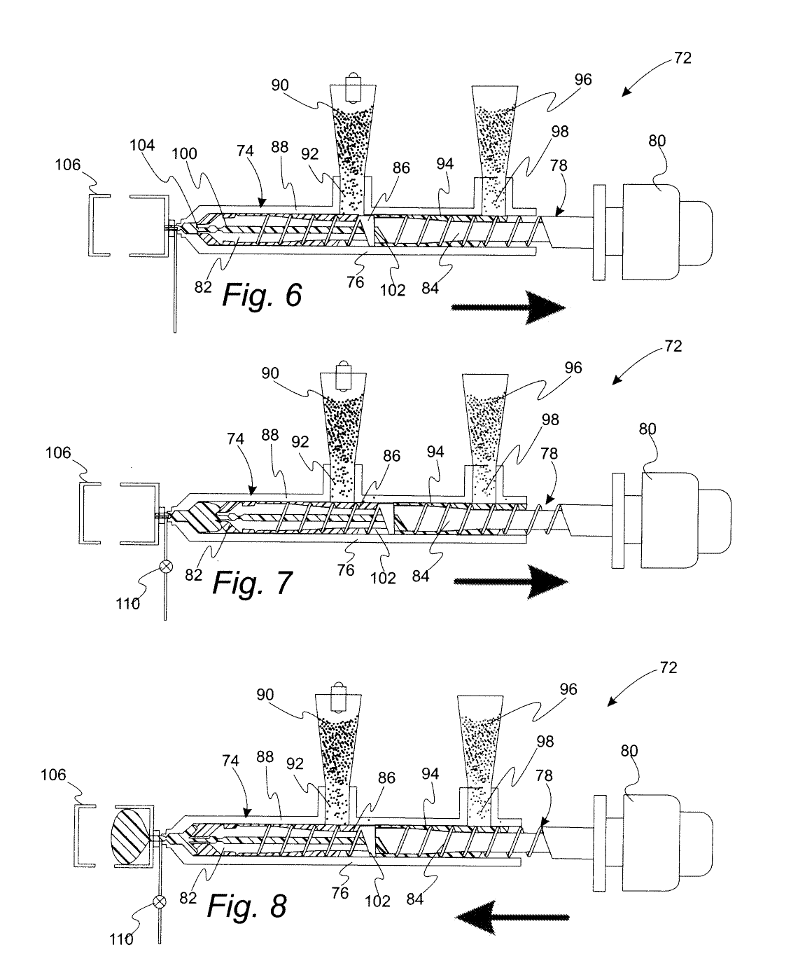

FIG. 5 illustrates a plastic injection molding system 44 of the present invention adapted to practice the method described with reference to FIG. 4 and make molded articles as shown in FIGS. 3a-3d. The molding system 44 is made up of a mold clamp 46 adapted to receive a mold for forming a plastic part. The mold has at least two mold sections 48 and 50 which open and close by moving relative to one another between a closed position illustrated and an open position (not shown) by mold clamp actuator 52. One of the mold sections is preferably provided with an ejector pin assembly 54 for ejecting the finished part upon opening the mold. The mold clamp 46 opens and closes the mold sections 48 and 50 in a conventional manner as well known by those skilled in this plastic molding art. The co-extruder unit 56 is provided adjacent to the mold clamp 46 for providing fluid plastic material through the internal mold cavity (not shown).

The co-extruder 56 is provided with at least two plastic extruders, 58 and 60, each providing a different plastic material to at least one outlet nozzle 62 which cooperates with the mold internal cavity. Co-extruders of this general type are known in the art and are illustrated in U.S. Pat. Nos. 4,609,516; 4,470,936; 4,715,802; and 4,722,679, all four of which are incorporated by reference herein for the purpose of illustrating co-extruder (co-injection) molding machines.

When thermoplastic material is to be used, each of the plastic extruders 58 and 60 will be provided with a heater for heating plastic material to a fluid state and a fluid pump such as a rotary auger or a piston ram for pressurizing the fluid plastic material and injecting the material through the injector nozzle 64 into the molded internal cavity. The co-extruder 56 introduces a controlled amount of each of the fluid plastic materials sequentially into the mold cavity. A gas assist system 64 is provided having a gas injection pin 36 illustrated in FIG. 3a which is coaxially aligned with injector nozzle 34, 62, illustrated in FIG. 3a-3d and FIG. 5. Alternatively, a gas injector pin can be located adjacent to and in close proximity to the plastic injection nozzle 34 and 62, provided that the pressurized gas is introduced into the fluid central region of the second plastic material once injected into the chamber cavity.

The fluid assist unit includes a regulator valve 66 to control the flow of pressurized gas or liquid from a supply line 68 into the mold cavity as described previously following the step of injecting meter quantities of each of the fluid plastic materials. A controller 70 is provided for regulating the sequential operation of the mold clamp, the two plastic extruders, and the gas assist unit to form a hollow part having an exterior shell made of a first plastic material and an inner structural shell of the second plastic material. The second plastic material is conformably molded in situ with the first plastic material about a central hollow cavity in a single molding operation. The controller 70 may be a single controller or may be two or more controllers with logic distributed throughout the system. Controller 70 may be connected to the other components of the system via hard wiring, a wireless network or through an ethernet or fiber optic network. Preferably, the controller will monitor the system's pressures and temperatures and the movement of the mold and the injector pins enabling the automatic manufacture of molded articles.

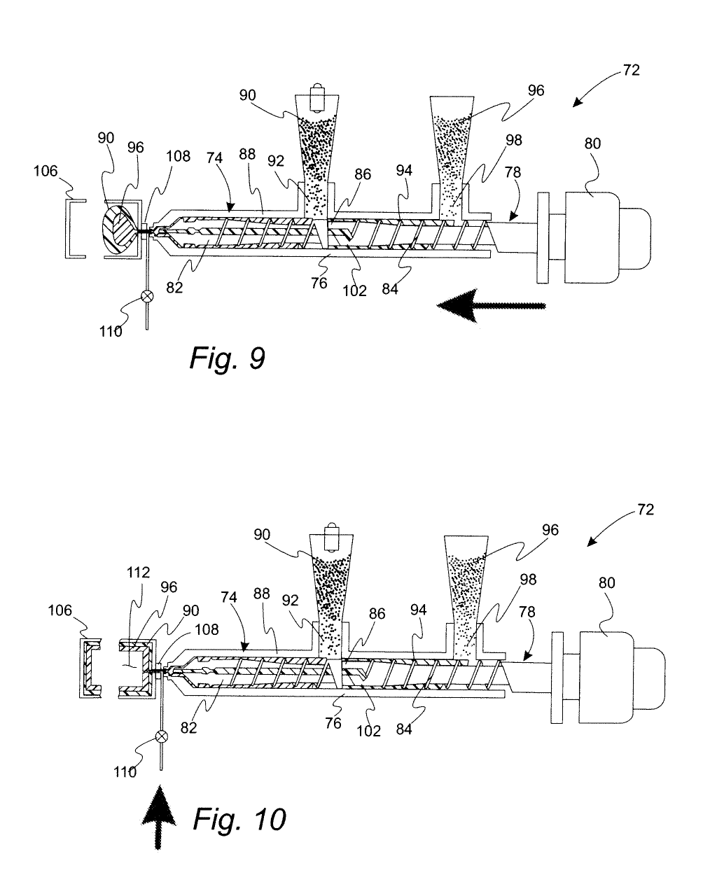

An alternative dual injection plastic molding system 72 is illustrated in FIGS. 6-10. FIGS. 6-10 are a sequential series of drawings illustrating the formation of a co-injected molded part formed of two different plastic materials and having a hollow central core. Co-extruders of this type are available from Spirex Corporation, 8469 Southern Blvd., Youngstown, Ohio, 44512.

Co-extruder 74 is specifically adapted to sequentially inject two different plastic materials into a mold in uninterrupted succession eliminating any hesitation marks in the final part resulting from the transition between different extruder heads. Co-extruder 74 is provided with a heated elongate cylindrical barrel 76 having an internal bore sized to receive an elongate feed screw 78 which is rotatably driven by a motor 80. Feed screw 78 has two separate screw auger regions; a forward region 82 and a rearward region 84 which are separated by a central land 86. A forward spiral chamber 88 is formed between the forward screw 82 and the cylindrical inner bore of barrel 76. Forward spiral chamber 88 is fed a first plastic material 90 through a radially extending port 92. A second spiral chamber is formed between the rearward screw portion 84 and the inner bore of barrel 76. A second material 96 is fed into rearward spiral chamber 94 via a feed port 98. Screw 78 is provided with a central axial passage 100 having an inlet port 102, rearward of land 86 opening into the forward most region of the spiral chamber 94 and an outlet 104 at the distal end of screw of 78.

In operation, as screw 78 is rotated by motor 80, the first plastic material 90 enters the forward spiral chamber 88 via port 92 where the plastic is heated to a fluid state and forwardly driven as a result of the screw rotation. Similarly, the second plastic material 96 enters the rearward spiral chamber 94 via port 98 where it is heated to a fluid state and driven forward by the rotation of the rearward screw segment 84. The plastic cannot flow beyond land 86 causing the plastic to enter inlet port 102 and flow axially to the outlet port 104. While screw 78 is being rotated by motor 80 in FIG. 6, it is not desired to inject the plastic into mold 106. Therefore, the screw 78 is moved axially rearward in the direction of the arrow indicated in FIG. 6 enabling the fluid first and second plastic materials 90 and 96 to accumulate in the injection chamber in the forward region of the barrel between nozzle 108 and the forward most end of screw 78. First and second materials 90 and 96 remain unmixed in the barrel with the first material adjacent the nozzle and the second material rearward of the first material adjacent the forward end of screw 78. Once the proper amount of plastic charge has been fed into the barrel, the screw 78 is advanced axially as shown in FIG. 8 initially displacing the first fluid plastic material into mold 106 as shown in FIG. 8. Continued movement of the screw 78 in the forward direction as shown in FIG. 9, causes the second fluid plastic material 96 to be displaced into the mold cavity 106 with the second plastic material, 96, being encapsulated within the first plastic material 90 as illustrated in FIG. 9.

When a substantial portion of the second plastic material is injected into mold 106, through nozzle 108, assist fluid valve 110 is opened allowing the fluid such as a pressurized gas or alternatively, a pressurized liquid is injected into the center of a second fluid plastic material 96 to form an internal cavity 112 as illustrated in FIG. 10. The assist fluid can be gas, such as air or nitrogen under pressure or alternatively, a liquid such as water or a steam/water mixture.

It should be further appreciated that the co-axial co-injection unit 74 described in reference to FIGS. 6-10 may be utilized in place of injection unit 58 in FIG. 5 in order to co-inject three plastic materials with each of the plastic materials being different from immediately adjacent material. In other words, all three materials may be different or the second material may be different than the material used for both the first and third injection periods. The term, “co-injection”, as used in this patent, means two or more plastic materials which are sequentially injected in the fluid state into a mold to form a multi-layer molded article. It is further appreciated that the fluid assist molding refers to gas assist, liquid assist or a combination thereof, where the assist fluid goes through a phase change (such as steam to water).

While FIG. 3 illustrates the formation of a spindle, it should readily appreciated that a railing post 14 may be similarly formed using the novel method and apparatus. While utilizing the present invention to manufacture railing posts, it is possible to manufacture shapes which are not suitable for an extrusion and more closely resemble a milled railing wooden post. When manufacturing a railing post, the second material layer may be thicker and contain higher concentrations of fillers such as wood fiber than a spindle, to reduce costs and to enable the post to accept conventional fasteners such as wood screws or the like. While it is possible to mold the post cap 72 as part of the post, preferably, the cap 72 will be a separate piece so that a wide variety of post cap designs can be installed on a post to provide different aesthetic appearances.

In order to manufacturer elongate extruded objects according to the present invention, one must establish process control settings for the particular materials to be used, the part shape and the desired finished part geometry. For example, the thickness of the vinyl layer will depend upon the temperature of the vinyl melt at the time of injection, the mold wall temperature, and the rate of injection. Similarly, the wall thickness of the structural material will depend upon the material melting temperature, the material temperature at the time of injection, the rate of injection as well as the fluid assist pressure. The amount of structure material and the ends of the elongate member is dictated by the wall thickness as described above, the mold cavity volume and the charge volume of the structural material. The larger the charge volume, the greater the concentration of structural material and the distal end of the part. The amount of structural material in the proximate end of the part is dictated, at least in part, by the fluid assist injection pin length. The process control parameters for a specific part to be formed can be readily determined by routine experimentation by one of ordinary skill in the injection molding field.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an molded elongate structural member, the method comprising:
installing a mold for forming an elongate structural member into a dual injection molding a machine provided with a fluid assist system;
injecting a first fluid plastic material into a first end of the mold partially filling the mold cavity and contacting the mold cavity wall;
injecting a second fluid plastic material into the region of mold occupied by the first fluid plastic material to displace the first material along the mold cavity in contact with the mold walls to form a thin layer separating the second material from the mold walls;
injecting a pressurized assist fluid into the center of the mold occupied by the second fluid plastic material forming a central cavity and displacing the first and second materials along the length of the mold cavity with the first material in contact with the mold walls to form a thin layer of first material separating the second material layer from the mold walls; and
venting the pressurized assist fluid and removing the molded part from the machine.

2. The method of claim 1 wherein the first fluid plastic material is a thermoplastic.

3. The method of claim 2 wherein the first fluid plastic material is a vinyl.

4. The method of claim 1 wherein the second fluid plastic material is a thermoplastic.

5. The method of claim 4 wherein the second fluid plastic material further comprises a filler.

6. The method of claim 4 wherein the second fluid plastic material further comprises a fiber filler.

7. The method of claim 4 wherein the second fluid plastic material further comprises a wood fiber filler.

8. The method of claim 1 wherein the assist fluid is a gas.

9. The method of claim 1 wherein the assist fluid is a liquid.

10. A method of making an molded elongate structural railing member, the method comprising:
installing a mold for forming an elongate structural railing member into a dual injection molding a machine provided with a assist fluid system;
injecting a first fluid thermoplastic material into a first end of the mold partially filling the mold cavity and contacting the mold cavity wall;
injecting a second fluid thermoplastic material into the region of mold occupied by the first fluid plastic material to displace the first material along the mold cavity in contact with the mold walls to form a thin layer separating the second material from the mold walls;
injecting a pressurized assist fluid into the region of mold occupied by the second fluid plastic material forming a central cavity and displacing the first and second materials along the length of the mold cavity with the first material in contact with the mold walls to form a thin layer of first material separating the second material layer from the mold walls; and
venting the pressurized assist fluid and removing the molded railing member from the machine.

11. The method of claim 10 wherein the mold installed in the molding machine is shaped to form a railing spindle.

12. The method of claim 11 wherein the first plastic material is vinyl and second fluid plastic material comprises recycled thermoplastic and wood filler.

13. The method of claim 10 wherein the mold installed in the molding machine is shaped to form a railing post.

14. The method of claim 10 wherein the dual injection molding machine is provided with two axially aligned plastic extruders which share a common two section drive screw, wherein the steps of injecting the first and second thermal plastic material further comprises rotating the drive screw to feed and accumulate two sequentially spaced charges of a first and second fluid thermoplastic material within the extruder and translating the feed screw axially to sequentially inject the first and second fluid thermoplastic materials into the mold.

15. The method of claim 10 wherein the assist fluid injected into the central cavity of the molded part is a pressurized gas.

16. An elongate railing member comprising:
a thin tubular plastic outer skin layer of first appearance quality material forming an exterior surface; and
a plastic inner layer of a second structural material different from the outer skin, formed conformably in situ with the plastic outer skin layer and defining a hollow elongate interior cavity in a single molding operation.

17. The railing member of claim 16 wherein the plastic outer skin layer is a thermoplastic.

18. The railing member of claim 16 wherein the plastic outer skin layer is a vinyl.

19. The railing member of claim 16 wherein the plastic inner layer is a thermoplastic material.

20. The railing member of claim 16 wherein the plastic inner layer is a fiber filled thermoplastic material.

21. The railing member of claim 16 wherein the outer plastic material is vinyl and inner plastic material comprises recycled thermoplastic and wood filler.

22. The railing member of claim 16 shaped in the form of a railing spindle.

23. The railing member of claim 16 shaped in the form of a railing post.

24. A railing member formed by the method of claim 10.

25. A railing spindle formed by the method of claim 10.

26. A plastic injection molding system comprising:
a mold clamp adapted to receive a mold for forming a molded plastic part, the mold having at least two sections defining a mold cavity and are movable relative to one another between an open and a closed position by a mold clamp actuator;
a co-extruder unit have at least two plastic extruders each providing a different plastic material to at least one outlet nozzle communicating with the mold cavity to sequentially inject a metered quantity of each fluid plastic into the mold cavity;
a fluid assist unit having a gas injector pin oriented proximate the co-extruder outlet nozzle, a controllable valve pressurized gas to the gas injector pin for introducing pressurized gas into the mold cavity sequentially following the injection of a metered quantity of each fluid plastic; and
a controller for regulating the sequential operation of the mold clamp, the two plastic extruders and the gas assist unit to form a hollow part having an exterior shell of a first plastic material and an inner structural shell wall of a second plastic material conformably molded in situ with the first plastic material in a single molding operation.

27. The plastic injection molding system of claim 26 wherein the two plastic extruders are provided with a heater for heating a thermoplastic material to a fluid state and a fluid pump for pressurizing the fluid plastic so as to inject the fluid plastic into the mold cavity via the outlet nozzle.

28. The plastic injection molding system of claim 24 when the two plastic extruders are coaxially aligned and share a two section drive screw which rotates to feed and accumulate two sequentially spaced charges of the different plastic material within the extruder and translated axially to sequentially inject the two plastic charges into the mold.
